(19) United States
(12) Patent Application Publication
(10) Pub. No.: US 2010/0209572 A1
(43) Pub. Date: Aug. 19, 2010

(54) PROCESS FOR PRODUCING A PRODUCT FOR FEEDING ANIMALS

(75) Inventor: Gianandrea GUIDETTI, Reggio Emilia (IT)

Correspondence Address: BROWDY AND NEIMARK, P.L.L.C.;624 NINTH STREET, NW, SUITE 300, WASHINGTON, DC, 20001-5303, US

(73) Assignee: SANYPET S.P.A, Bagnoli di Sopra (IT)

(21) Appl. No.: 12/705,363

(22) Filed: Feb. 12, 2010

Related U.S. Application Data
(63) Continuation-in-part of application No. PCT/IB2008/002107, filed on Aug. 4, 2008.

(30) Foreign Application Priority Data
Aug. 8, 2007 (IT) PD2007A000274

(51) Int. Cl. A23K 1/16; A23K 1/18; A23K 1/20

(52) U.S. Cl. 426/285

(57) ABSTRACT

Process for producing a product for feeding animals comprising a first step of producing kibbles for therapeutic purpose through a first step of providing at least one thickener component in form of powder, at least one hydrophilic mineral in form of powder and at least one therapeutic substance in form of powder for curing animals, containing thermolabile and/or oxide-reducing active ingredients; a step for mixing such ingredients, aimed at homogenising such ingredients together; and a step for dry-pressing mixed powders to obtain compact agglomerates in form of kibbles, for therapeutic purpose, having lipophile characteristics and comprising a moisture percentage lower than 6%. The process also comprises a step for producing kibbles for nutritional purpose by means of extrusion starting from a mixture, a step for coating with fat, wherein the latter kibbles are coated with fat on the surface, a mixing step, wherein the kibbles for therapeutic purpose are mixed at percentages comprised between 5 and 15% to the kibbles for nutritional purpose, for uniform distribution therein
The process further comprises a step for absorbing—by the kibbles for therapeutic purpose—part of the surface fats of the kibbles for nutritional purpose, such absorption step being at least partly performed during the mixing step.

### FIELD OF APPLICATION

The present invention concerns a process for producing a product for feeding animal according to the introduction of claim 1.

The invention falls within the animal food and care products industry, in particular for animals of the domestic type such as dogs and cats.

The product for feeding animals produced by the process subject of the present invention shall be advantageously employed for administering drugs, supplements, vitamins, physiotherapy substances or substances sensitive to heat and/or oxidising/reducing substances and more generally for administering active ingredients for therapeutic, medical or prevention purposes.

### PRIOR ART

As known in the field of veterinary, in particular for the care of domestic animals, of particular concern is the problem regarding administration of drugs or physiotherapy substances, together with the food products in a form capable of maintaining the properties and the activity of the therapeutic active ingredients intact.

Currently, for practical reasons, many drugs used for animal care are administered by introducing them directly into the food products.

As a matter fact, drugs, supplements and the like usually do not have a taste pleasant to animals and they would be easily detected and rejected if administered separately.

This method of administering drugs and supplements to animals by adding them to the food product is widely considered a consolidated method offering indisputable practical advantages.

However, such administration practice, raises problems regarding the correct dosage and preservation of the activity of the active ingredients inside the food products.

Food products for animals are usually obtained according to modern production process in form of kibbles, which have proved to be particularly suitable for feeding various animal species and in particular for domestic species such as dogs and cats.

Kibbles are obtained by means of hot extrusion industrial processes starting from multi-components which are dried and packaged once shaped into kibbles.

More in detail, such industrial processes generally provide for a first mixing step, wherein one or more cereals or their byproducts, meals, protein concentrates of animal or vegetable origin, fats are suitably mixed together in a dosed manner, with the aim of obtaining a multicomponent mixture intended to make food products specifically prepared according to the nutritional needs of the type of animal they are intended for.

The mixture of the components thus obtained is introduced into an extrusion chamber where it is subjected to heating, generally in the range of 85° C. to 130° C., before being forced by the action of one or two worm screws to pass through the holes of a die arranged on the head of the extruder. The mixture exiting from the die is cut by blades into the shape of the kibbles desired.

Once dried, the product is free of microbial contaminations and particularly digestible.

Subsequently, in order to increase the tastefulness of the kibbles it is possible to subject the extruded granules to fat-covering processes and/or spraying with products of animal origin such as for example meat, giblets, fats.

This final step of coating with fat and/or spraying is followed by a maturation step, wherein the kibbles are kept in the so-called big bags, i.e. in large flexible containers, for at least eight hours, before being sealed in the packages. Such maturation step is required to allow the homogenization of the moisture content of each kibble. As a matter of fact, upon exit from the drier the kibbles have a moisture gradient between the core and the outer surface, in particular the moisture content thereof is higher at the core with respect to the outer surface. Thus, the maturation step allows redistributing moisture over the entire volume of each kibble and the possible release of excess moisture by the kibbles, preventing this from leading to the proliferation of moulds, fungi or bacteria in the kibbles sealed in the packages.

Should the kibbles have been previously subjected to fat covering and/or spraying processes, there occurs the simultaneous migration of the fats deposited on the surfaces of the kibbles inwards the same during the step of maturation. Absorption of such fats to the core of the kibbles ensures the latter have a homogenous flavour.

Should the kibbles be used as vehicles for administering drugs it should be borne in mind that the production processes indicated above subject the medical substances, vitamins, phytotherapy extracts, and active ingredients contained therein to considerable thermal stress.

Most of these active ingredients are partially inactivated by the heat losing their active antioxidant function. In particular, many vitamins are extremely sensitive to the temperature, that is they are entirely thermolabile even in the presence of minimum thermal excursions and they might already deteriorate at temperatures slightly higher than ambient temperature.

Furthermore, during the production process, the drugs come into contact with mixtures having a considerable percentage of water or moisture which facilitate the oxidation and functional deterioration of most of the active ingredients.

Lastly, thermal stresses and moisture linked to the current production processes quickly deteriorate the activity characteristics of the drug principles added to the kibbles.

Hence most processes generally used for obtaining kibbles did not prove suitable for producing a product for feeding animals capable of allowing simultaneous administration of medical substances to the latter.

In order to overcome this drawback, special dual component kibbles obtained through co-extrusion and provided with an external shell coating to protect a core containing the active ingredients of the drug or sensitive substances, have been studied and introduced into the market.

More in detail, for example the U.S. Pat. No. 6,117,477 patent tackles the problem of producing food for animals capable of reducing the use of water and allowing to add functional, nutritional and pharmaceutical components protected against heat, light and oxygen for example, having anti-inflammatory functions, curing functions for problems regarding the respiratory system, to improve the immune response, with antioxidation functions, with parasite control functions, with antibiotic functions etc. This patent described a process for producing a dual component product provided by means of co-extrusion wherein the internal component is obtained without passing through aqueous phases, has a percentage of moisture lesser than 15% by weight and contains a mixture of lipids and solid ingredients forming a cream; while the second component covers the first component completely, such product has a percentage of moisture lesser than 20% by weight and it contains at least one ingredient containing a carbohydrate, a fat, a protein or their combination.

The U.S. Pat. No. 6,254,910 patent proposes providing a food product vehicle for administering to animals various nutritional, functional or pharmaceutical additives sensitive to heat, light or oxygen, to prevent them from being altered or destroyed by processes including heat or acid conditions. For this purpose, the patent provides for the production of an edible dual component product obtained through co-extrusion of a first component obtained without aqueous phases, such product having a percentage of moisture lesser than 15% by weight, containing a mixture of lipids and solid ingredients forming a cream, and containing one or more ingredients sensitive to heat, light or oxygen or one or more ingredients having unpleasant colour or odour and a second component with a percentage of moisture lesser than 20% by weight and containing at least one ingredient containing a carbohydrate, a fat, a protein or their combination and completely coating the first component in form of cream and thus maintaining the vitality of the ingredient sensitive to heat, light, oxygen or with unstable process.

Analogously, the U.S. Pat. No. 6,506,401 patent provides for the production of an edible product for animals useable for treating the digestion of hairballs in a form comprising an emulsion with malt syrup with an aqueous and an oil phase; and a second covering edible component different from the past and applied to coat in order to encapsulate the formulation.

Though they allowed enhancing the effectiveness of the drugs partially preserving the activity of their active ingredients, the abovementioned co-extrusion processes did not allow achieving particularly satisfactory results.

As a matter of fact, the extrusion process requires providing the component at the core of the food product, containing the active ingredients, in form of cream to be extruded and thus with a moisture, though low, incompatible for a complete preservation of the properties of the active ingredients of the drugs.

Furthermore, the co-extrusion process still requires heating the external shell which transmits—by conduction—part of the heat to the heart inserted mixture. Such heat is enough to inhibit the activity of most curative principles contained in drugs added the heart-shaped component.

Furthermore, the co-extrusion process in practice proved quite expensive and complicated to manufacture.

### PRESENTATION OF THE INVENTION

In this situation, the problem on which the present invention is based is that of providing a process for producing a product for feeding animal capable of ensuring preservation of chemical/physical conditions which do not damage, deteriorate or jeopardise the functionality of the active ingredients drugs, vitamins, supplements, phytotherapy substances and active ingredients for therapeutic purposes in general, contained in the same product.

Another object of the present invention is that of providing a process for producing a product for feeding animals, comprising kibbles for feeding purposes and kibbles for therapeutic purposes which are not differentiated by the animals they are intended to feed.

Another object of the present invention is that of providing a process for producing a product for feeding animals, capable of conferring the product a balanced content of nutritional substances and active ingredients, thus guaranteeing the proper ration of such substances and such ingredients to the animal, regardless of the dose of the product administered to the latter.

These and other objects are all attained by means of the kibble for animals according to the annexed claims.

The technical characteristics of the invention, according to the abovementioned objects, are clearly observable from the content of the claims below and the advantages of the same shall be clearer in the detailed description hereinafter, provided with reference to an embodiment strictly for exemplifying and non-limited purposes.

### DETAILED DESCRIPTION

The process subject of the present invention is intended to be used for producing a product for feeding animals having both the therapeutic and nutritional function and comprising, for such purpose, kibbles for therapeutic purpose homogeneously mixed at predetermined percentages in a greater amount of kibbles intended for feeding animals.

The kibble for therapeutic purpose comprised in the product for feeding animals obtained through the process subject of the present invention can be otherwise intended as a tablet, or still as a biscuit or granule, without for this reason departing from the scope of prevention of the present patent.

The process subject of the present invention comprises a step for producing kibbles for therapeutic purpose.

Such production step is obtained through an initial step of providing the following ingredients: one or more thickener components in form of powder, one or more hydrophilic minerals in form of powder and one or more therapeutic substances in form of powder for curing animals, containing thermolabile and/or oxide-reductionactive ingredients. Then, there ensues a step of mixing such ingredients, aimed at homogenising them together, and, subsequently, a step of dry-pressing the mixed powders, to obtain compact agglomerates in form of kibbles.

More in detail, the thickener component is introduced among the ingredients of the kibbles for therapeutic purpose for compacting the ingredients together as indicated above by means of cold and dry compression. The hydrophilic mineral is introduced for absorbing the moisture from the other components of the tablet and facilitate the separation of the mixture compacted in form of kibble by the press. The therapeutic substances with thermolabile and/or oxide-reduction active ingredients are introduced for treatment purposes.

The kibble for therapeutic purpose is thus obtained starting from a mixture of ingredients in the form of powder which are cold pressed by means of simple pressing without adding liquids and thus without any drying step. During the production process, the kibbles, in particular, do not exceed the temperature of 25° C., not even under the effect of the friction force exerted during compression. Such expedients ensure maintenance, during the production step, of chemical/physical conditions that do not damage, deteriorate or jeopardize the functionality of the therapeutic substances introduced into the kibbles.

The therapeutic substance to be added to the kibble for therapeutic purposes shall be selected, separately or combined with other substances depending on the curative purpose intended to be achieved as better specified hereinafter.

Given that no hot phase is used so as to allow starch to reticulate compacting the ingredients, it is necessary to add one or more thickening substances capable of performing the task of compacting ingredients, even in a cold manner, by means of simple compression.

The thickening substance shall preferably be selected from one or more ingredients selected from among: animal meal, such as for example fish meal, carob meal, calcium dibasic phosphate, potato meal, maize starch, maltodextrine, animal protein hydrolysates or vegetable protein hydrolysates in powder form.

Preferably, a measured combination of these ingredients can be selected as, for example, 40-55% of calcium dibasic phosphate, 5-25% of carob meal, 25-50% of maize starch.

The considerable amount of calcium phosphate is justified by the aim of providing the required amount of salts for the animals as well as the fact that it is a good compacting agent. Such amount can be reduced in case the kibble is mixed with other kibbles, for feeding purposes, already rich with such salts.

Advantageously, it was discovered that the thickening substance, added to the mixture at a quantity comprised in the range of 60-80% and preferably at 70%, serves the double purpose of being highly compacting by means of compression and being considerably tasty for the animals. Furthermore, the thickening substance alongside the other components, when the kibble is added to and mixed with kibbles for the traditional type of feeding, that is treated externally with appetizing fats, leads the kibble to absorbing part of this part and thus be more tasty for the animals.

Surprisingly, the absorption of this part confers to the kibble—due to the thickening substance contained therein—a very dark colour (dark brown) making the kibbles subject of the present invention easily recognizable inside a mixture with other kibbles for feeding purposes. This is a clear advantage given that it allows a visual control in a manner such that the kibbles subject of the present invention for curative purposes are always administered to the animal substantially at the same doses during the normal administration of food. Otherwise, it allows increasing or reducing the daily dose of curative kibbles intended to be administered to the animal by simply picking them up from the mixture. Furthermore, such recognizability is obtained in an entirely natural manner without requiring use of synthetic colorants.

According to a preferred embodiment of the present invention, the kibble for therapeutic purpose is made of thickener components made up of animal protein hydrolysates and vegetable protein hydrolysates, both in powder form. Advantageously, the thickener components are in particular a combination comprising 40-60% of fish protein hydrolysates and 40-60% of potato protein hydrolysates.

The introduction of protein hydrolysates in the kibbles for therapeutic purpose, makes the taste and flavour of the latter similar to the taste and flavour of the kibbles for nutritional purposes, which in turn comprise animal meals, vegetables and protein hydrolysates, thus facilitating the consumption of the entire product by the animal. Furthermore, the hydrolysates have a high digestibility.

The protein hydrolysates introduced into the kibbles for therapeutic purpose are in form of powder, in order to allow easy compressing of the ingredients and not interfere with the dry-pressing process used for making the kibbles.

As previously considered, the kibble for therapeutic purposes comprises one or more hydrophilic minerals, added to the mixture at a quantity comprised in the range of 15-20% for absorbing the moisture from the other components of the tablet and facilitate the separation of the mixture compacted into kibbles by the press.

Preferably, such mineral is magnesium stearate, silica, calcium carbonate or dicalcium phosphate, which, by absorbing the moisture, make the other substances more dry preventing the active ingredients from oxidising upon contact with the oxygen of the water and avoiding complications of the bacteria type, encouraged by the moisture. Furthermore, such minerals facilitate the compaction of the powders, given that they reduce the force of friction, i.e. the friction, present between the particles of the powders, making them easier to compress.

The therapeutic substance introduced at amounts up to 10% in the kibbles for therapeutic purposes is selected separately or in combination, preferably in the family of products comprising: vitamin C, lysozyme, bioflavonoids, shark cartilage, contoutine, glucosamine, propolis, Echinacea, Astaxanthin, Papaya, Aloe, Ginseng, Pineapple, Rose hip, Papaya, Resveratrol, Carnetin, Resveratrol, and other phytotherapy substances, pharmaceutical ingredients or principles available in the market having stability problems under oxygen or heat.

The vitamins normally added to the kibbles, under cold conditions, when coating with fat, shall also be advantageously added in the formulation of the kibble, for therapeutic purposes, subject of the present invention.

The kibbles for therapeutic purpose thus obtained, have lipophile characteristics and, according to an important characteristic thereof, they comprise a moisture percentage lower than 6% during production. Such characteristic allows keeping the characteristics of the functional activity of the drugs, vitamins, supplements, phytotherapeutic substances, active ingredients, generally for therapeutic purposes, introduced into the kibble and better specified hereinafter intact, given that such characteristics would otherwise be deteriorated by the action of water and oxygen contained therein.

Though containing carbohydrates and other substances for feeding purposes, the kibbles for therapeutic purposes obtained according to the process subject of the present invention are not solely intended for feeding animals but substantially to be a vehicle for administering therapeutic substances.

Thus, the process subject of the present invention provides for obtaining kibbles for feeding purposes. The latter are obtained by means of extrusion starting from a mixture of components introduced into an extrusion chamber and forced by the action of at least one worm screw, passing through the holes of a die arranged at the head of the extruder. The mixture exiting from the die is cut by blades in the desired form of kibbles.

Lastly, the extruded kibbles are subjected to fat coating, for example by means of spraying processes using products of animal or plant origin such as for example meat, giblets, fats (the so-called “digest” in the specialised technical language).

Advantageously, the kibbles for nutritional purposes obtained for making the product for feeding animals according to the process subject of the present invention are hyper-coated with fat on the surface, i.e. they are coated with fat on the surface with a higher dose of appetizing fatty substances. More in detail, the dose of appetizing substance used for coating such kibbles with fat is increased by 3-8% by weight respect to the dose usually used for obtaining the kibbles used for nutritional purpose having a uniform fat coating on the surface. Such dose for hyper-coating with fat is substantially the one that shall be transferred to the kibbles for therapeutic purpose in an absorption step provided for.

Thus, provided for is a step for mixing the kibbles for nutritional purpose with the kibbles for therapeutic purpose.

Advantageously, the kibbles for therapeutic purposes are mixed in the amounts of 5-15% by weight among kibbles for feeding animals and, preferably, they are added to the latter at a percentage equivalent to 7% by weight. Preferably, the kibbles for therapeutic purpose are mixed in the kibbles for nutritional purpose at a percentage amount equivalent to 5-15% with respect to the total number of kibbles and advantageously about 10%.

More in detail, the mixing step provides for that a first dose of kibbles for nutritional purpose and a second dose of kibbles for therapeutic purpose be supplied, by means of vertical screw volumetric extractors, respectively from a first and a from a second open collection container, collected inside which are two different types of kibbles.

The vertical screw extractors transfer the first and the second measured dose of kibbles from the respective gathering containers advantageously to a conveyor screw, preferably horizontal. The rotation of the horizontal screw determines a homogenous distribution of the kibbles for therapeutic purpose among the kibbles for nutritional purpose without simultaneously damaging the kibbles and in particular without jeopardizing the integrity of the particularly friable kibbles for therapeutic purpose.

In addition, the latter mixing step is also used to execute the absorption step wherein the kibbles for therapeutic purpose absorb part of the appetizing substances, i.e. the surface fats, which are distributed on the surface of the kibbles for nutritional purpose.

As a matter of fact, the kibbles for therapeutic purpose, are not subjected to the fat coating and/or spraying step but, having lipophile characteristics, they acquire the appetizing fatty substances upon contact with the kibbles for nutritional purpose. In this manner, part of the appetizing substances, mainly made up of concentrated protein hydrolysates, such as for example chicken liver extract, and offal generally, substances being particularly pleasant to dogs and cats, are transferred onto the surface of the kibbles for therapeutic purpose also making the latter particularly appetizing.

More in detail, transfer of such appetizing substances from the surface of the kibbles for nutritional purpose to the surface of the kibbles for therapeutic purpose occurs by capillarity and similarity with the lipophile organic substances, i.e. hydrolysates, preferably present in the kibbles for therapeutic purpose.

The hydrolysates present in the tablets have similarities with the kibbles for nutritional purpose i.e. they have a fat part which allows transferring the fats from kibbles for nutritional purpose to the kibbles for therapeutic purpose.

The transfer may also occur by capilarity for example in the presence of calcium carbonate present as a thickener in the kibble for therapeutic purpose.

The appetizing fatty substances which are distributed on the kibbles for nutritional purpose during the step of coating with fat advantageously contain lipophilic antioxidant substances.

As a matter of fact, the kibbles for therapeutic purpose are preferably produced without using antioxidants, given that the small amounts required would make uniform distribution thereof complex.

Otherwise, the acquisition of the antioxidant substances transferred by the appetizing fatty substances from the kibbles for nutritional purpose allows optimal distribution of the antioxidant substances among the kibbles for therapeutic purpose.

Therefore, alongside the appetizing substances, the kibbles for therapeutic purpose absorb—from the kibbles for nutritional purpose—the antioxidant substances and in particular natural preservatives, such as tocopherols, or vitamin E, for example derived from rosemary extracts.

Following the acquisition of such fats, provided more than required on the surface of the kibbles for nutritional purpose, the kibbles for therapeutic purpose are subjected to the increase of the amount of fats contained therein comprised between 4% and 6% and, also absorbing part of the moisture contained in the kibbles for nutritional purpose, they are subjected to a weight increase equivalent to about 5-15% with respect to the initial weight thereof, and in particular equivalent to about 10%, acquiring a final density similar to that of the kibbles for nutritional purpose.

Advantageously, the density of the kibble for therapeutic purposes subject of the present invention is similar to the one of the kibble for feeding purposes to guarantee its uniformity of distribution inside the mass of the same kibbles for feeding purposes, capable of resisting over time and not causing therapeutic kibbles for example to heap at the bottom of the package making their administration to the animals non-uniform.

The uniformity in the distribution is facilitated by the shape of the therapeutic kibble subject of the invention, which is provided with corners preventing its easy movement inside a mass of other kibbles for feeding purposes. In particular, preferable is a prism shape with substantially triangular upper and lower faces.

Thus provided for is a maturation step immediately subsequent to the mixing step, during which the food product formed by the kibbles for therapeutic purpose and by the kibbles for nutritional purpose mixed together and distributed homogeneously is kept in open containers. Continuing during such maturation step is the abovementioned absorption step which had started during the mixing step, wherein the transmigration of the surface fats of the kibbles for nutritional purpose to the surfaces of the kibbles for therapeutic purpose occurs due to the close contact between kibbles for therapeutic purpose and kibbles for nutritional purpose.

During this step, the moisture present in the kibbles for nutritional purpose obtained by extrusion is redistributed over the entire volume of the same kibbles for nutritional purpose and there occurs the simultaneous release of excess moisture towards the external environment. Simultaneously, the fats distributed during the step of coating with fat on the surface of kibbles for nutritional purpose are partly absorbed in the kibbles themselves, penetrating towards the core of the latter, they are partly transferred onto the kibbles for therapeutic purpose where they start—also in this case—spreading inwards.

Thus, the maturation step preferably occurs only after the step of mixing the two types of kibbles, in order to facilitate the passage of fats onto the kibbles for therapeutic purpose while such fats are still mainly distributed on the surfaces of the kibbles for nutritional purpose.

This allows preventing the appetizing substances sprayed on the surface of the kibbles for nutritional purpose from being exceedingly absorbed to the core and not be easily transferred to the surfaces of kibbles for therapeutic purpose.

Therefore, advantageously the step of maturation with the kibbles mixed together occurs within the eight hours subsequent to the step of coating the surface of the kibbles for nutritional purpose with fat.

Furthermore, preferably, such maturation step is preferably carried on for at least 24 hours with the aim of allowing sufficient transmigration of the fats present on the surfaces of the kibbles for nutritional purpose onto the surface of the kibbles for therapeutic purpose.

Due to the absorption of fats, the kibbles for therapeutic purpose are subject to a consolidation step, wherein the fatty substances withhold the ingredients of kibble for therapeutic purpose compact, hence being less fragile and friable and hence being easy to transport and package without being damaged.

In any case, in order to prevent possible powders of the kibble for therapeutic purpose impregnated with fats acquired from the kibbles for nutritional purpose from facilitating oxidation phenomena in the product, advantageously provided for is a step for screening the kibbles after the maturation step before the packaging step provided for. The powder-like component impregnated with fats coming from kibbles for nutritional purpose generated from mixing kibbles for therapeutic purpose with kibbles for nutritional purpose, provides an extensive exchange surface on which oxidation reactions may be triggered, leading to a subsequent inactivation of the natural antioxidants present in appetizing fatty substances and, at contact with the tablets for therapeutic purpose, they facilitate the deterioration of the active ingredients present therein.

According to the first embodiment of the product for feeding animals produced by the process subject of the present invention the product is provided with a kibble for dental hygiene and for protecting the vegetative system and the upper respiratory tract of dogs and cats preferably within a complete product providing for the use of the abovementioned kibble alongside kibbles for feeding purposes.

According to the latest statistics, most dogs and cats, especially the small and medium sized ones, suffer pathologies regarding the oral cavity. Bad breath, tartar and gingivitis are common, very disturbing and, above all, they strongly influence the relationship with the owner of the animal.

Advantageously used in the therapeutic kibble are natural active ingredients such as Salvia, Thyme, Propolis, Vitamin C, Bioflavonoids, Lysozyme, combined into feeding kibbles in particular obtained through percentages of sea fish (omega-3 and omega-6 fatty acids , extremely high protein value and high digestibility) and meat of organic origin in order to obtain the correct amount of protein.

Another product intended for curing joint problems provides, in the kibbles for therapeutic purposes, for use of active ingredients such as chondroitin, glucosamine or shark cartilage, such substances being extremely thermolabile.

The product produced by the process subject of the present invention allows treating, in a practical and effective manner, many diseases caused by immunity deficiencies or infections and provides a diet efficient as well preventing various diseases by means of its simple administration.

Many studies show that the immunity system is the system most vulnerable to the presence of various types environmental and food contaminations. As a consequence, the same system reacts, either in an excessive manner (allergies, autoimmune diseases), or in an insufficient manner (greater vulnerability to cancers and infective diseases such as, for example, Filiaris, Rickettsiosis, Lyme disease, Leishmaniosis).

Therefore, the active ingredients of the natural components (Echinacea, Astaxanthin, Papaya, Aloe) can be, for example, added to the kibble for therapeutic purposes and they allow providing a complete product in particular in combination with kibbles for feeding purposes comprising sea fish (omega-3 fatty acids, very high protein value and high digestibility) sunflower oil (slow tendency to oxidation). Such product is capable of offering a fundamental contribution both for preventing such diseases and during the specific therapy.

Further active ingredients that can be used in the kibbles for therapeutic purposes are Ginseng, Pineapple, Rose hip, Papaya, Resveratrol, Carnetin and Resveratrol selected by specialised chemists and veterinarians, and present in many formulations.

Considered more in detail hereinafter are some important therapeutic substances which, separately or combined, can be included in the formulation of the kibble for therapeutic purposes introduced into the product produced by the process subject of the present invention.

For some of them, no specific study was performed aimed at highlighting the degree of reduction of the activity of the active ingredients therein upon heating.

In its activity and due to its characteristics, the shark cartilage helps preventing inflammatory phenomena and reinforcing the immune defences. Shark cartilage is naturally rich in calcium, phosphorous, proteins, mucopolysaccharides, vitamins and collagen.

Chondroitin sulphate, jaluronic acid and glucosamine—present naturally—help regenerating the cartilaginous tissues, enhancing the health conditions of all the joints at the same time. Used in the present kibble, is a powder obtained through enzymatic hydrolysis of the shark skeleton.

The biological activity of the shark cartilage is particularly thermolabile, and it has been the subject of various researches which have confirmed that it is capable of:

acting as an effective natural anti-inflammatory;

accelerating the cicatrisation processes and contributing to the reinforcement and the recovery of the bone tissues, stimulating the cellular regeneration processes;

enhancing the production of antibodies by the animal organism, improving the immune response;

inducing a quick neuromuscular recovery.

The substance in question can also be indicated as a food adjuvant for therapies intended for various pathologies, among which: arthritis, dermatitis, psoriasis, herpes and ocular pathologies such as the cataract. Such substance helps the organism to prevent and fight the formation of new blood vessels in the tissues through its antiangiogenetic factor in a natural manner.

The Shark cartilage must contain 100% of dried and frozen cartilage, in a manner such to maintain the maximum bioactivity and effectiveness.

This is guaranteed by a process which provides for collecting the cartilage, controlling its quality, dehydrating under vacuum and pulverization strictly performed “cold”: no boiling, cooking, enzymes or acids are used in the process.

Thus, this allows maintaining the maximum degree of effectiveness of the proteins and mucopolysaccharides which are not damaged in their activity when producing the kibbles subject of the present invention.

The Echinacea is a plant of the Composite Tubiflore family, from whose roots useful extracts are obtained for curing diseases caused buy cold and for the prevention of minor respiratory pathologies (laryngitis, tracheitis, cough)

Taking Echinacea regularly may help preventing (especially during periods in which the organism is subjected to greater stress), shorten or soften the symptoms of diseases linked to cold, against attacks of flu, all the way to lip herpes.

It is also useful for prevention. A protective beneficent effect can also be observed regarding all the minor pathologies (coughs, sinusitis, colds).

Aloe Barbadensis is a succulent plant typical of the desert areas of Africa, Spain, Australia, Central America. Such plant is used for preventing and treating neoplastic diseases.

The gel is the most effective and non-toxic part of the plant.

The gel obtained from squeezing Aloe leaves proved to have anti-inflammatory activities. As a matter of fact, the gel is capable of reducing the degree of inflammation and stimulating the production of a new collagen. Some studies have shown that Aloe Vera Gel is capable of accelerating the natural healing process.

Aloe Vera Gel is capable of inhibiting the growth of pathogenic bacteria, especially at intestinal and skin level.

The bioflavonoids, present in considerable amounts especially in the citrus fruits we use, selectively act to maintain the natural integrity of the capillaries. From this point of view, their role is essential, given that the wellbeing and proper operation of the cells of the tissues depends on the nutrition they receive, which occurs through numerous capillaries present in the tissue.

The bioflavonoids serve for transporting hydrogen and for capturing circulating radicals, in a synergic manner with vitamin C. Then they act as important agents for detoxifying our organism.

All the vegetable parts of the plant contain important phytonutrients such as vitamins, mineral salts and carbohydrates, but the most important component for the phytotherapy activity is papain, an enzyme belonging to the same family as the pineapple bromelain.

Papain belongs to the group of proteinase, that is the enzymes that convert proteins into amino acids.

Through a conservative extraction process, obtained from the papaya fruit is a powder concentrated and standardised in proteolytic activity. The papaya extract is pale yellow in colour and soluble in water; it is stable but inactivated by heat, just like all enzymes.

The Papaya has a digestive, cicatrising, anti-inflammatory as well as antiseptic action and it is useful for stomatitis and gingivitis. The large amount of vitamins, mineral salts and carbohydrates guarantees various actions: regenerating, cytoenergetic and regulating.

Taking compounds with an antioxidant activity was associated to a reduction of risks regarding the occurrence of chronic diseases such as cardiovascular diseases and cancer. There is an ever-growing number research protocols for studying the effects of a specific antioxidant compound on health: Resveratrol.

Resveratrol is found in red wine and it seems to be one of the factors involved in the so-called “French paradox”, that is the low incidence of cardiovascular diseases in France regardless of a diet rich in fat and red meat.

Taking this powerful antioxidant was associated to the reduction of risks related to contracting chronic diseases.

Though collection of further pharmacological and clinical regarding the activity of this compound is required, the preliminary results can already confirm the rationality of using Resveratrol as an ingredient with antioxidant properties capable of protecting the organism against oxidation stress, in particular regarding the cardiovascular system.

Regarding the immunity system, Vitamin C performs an action of enhancing the activity of the cells meant to defend the organism. Use of high doses of Vitamin C compensates its excessive loss during bouts of fever. Due to the intracellular transport it increases the bioavailability of the active ingredient (carrier effect). Furthermore, it has a protection action on the vascular system and it is good for activating defensive and immunity powers of the system.

Vitamin C performs a protection action, particularly in synergy with the bioflavonoids; thus, these two principles are essential to each other. Only the natural extracts guarantee the simultaneous presence of two active principles. Vitamin C facilitates the absorption of iron especially from vegetable sources. As a matter of fact, a proper daily supplementation with the vitamins, preserves the integrity of the animal and facilitates its wellbeing, in that it contributes to restore the delicate balance on which its metabolism is based.

Sage and Thyme are known for their antiseptic, antiedemigene and cicatrising properties. The phytocomplexes held therein, have values extremely rich in active ingredients with important or protective actions.

Sage and Thyme are efficient at fighting the excessive formation of catarrh in bronchial form. They are used as astringents, antiseptics, expectorants and mycolytics in the inflammations of the oropharyngeal cavity and they are also useful in asthmatic coughs.

Propolis is produced by bees and it is a brown coloured resin substance.

1. Process for producing a product for feeding animals comprising the following operative steps:
a step for producing kibbles for therapeutic purpose through:
a first step for providing the following ingredients:
at least one thickener component in form of powder;
at least one hydrophilic mineral in form of powder;
at least one therapeutic substance in form of powder for curing animals, containing thermolabile and/or oxide-reduction active ingredients;
a step for mixing said ingredients aimed at homogenising said ingredients together; and
a step for dry-pressing said mixed powders to obtain compact agglomerates in form of kibbles, for therapeutic purpose; said kibbles for therapeutic purpose having lipophile characteristics and comprising a moisture percentage lower than 6%;
a step for producing kibbles for nutritional purpose by means of extrusion starting from a mixture;
a step for coating with fat, wherein said kibbles are coated with fat on the surface;
a mixing step wherein said kibbles for therapeutic purpose are mixed at percentages comprised between 5 and 15% with said kibbles for nutritional purpose for uniform distribution therein;
a step for absorbing—by said kibbles for therapeutic purpose—part of the surface fats of said kibbles for nutritional purpose, such step being at least partly performed during said mixing step.

2. Process for producing a product for feeding animals according to claim 1, wherein said step of coating with fat distributes on said kibbles for nutritional purpose a higher dose of appetizing fatty substances by 3-8% by weight, which is substantially transferred on said kibbles for therapeutic purpose during said absorption step.

3. Process for producing a product for feeding animals according to claim 1, wherein said absorption step partly occurs during said mixing step and partly during a subsequent maturation step, wherein the mixture of said kibbles for therapeutic purpose and said kibbles for nutritional purpose is kept in open containers.

4. Process for producing a product for feeding animals according to claim 1, wherein said appetizing fatty substances distributed on the kibbles for nutritional purpose during said step of coating with fat contain lipophile antioxidant substances, which are transferred on said kibbles for therapeutic purpose during the absorption step then spread alongside the appetizing substances among the kibbles for therapeutic purpose.

5 Process for producing a product for feeding animals according to claim 3, wherein said maturation step 1 for at least 24 hours.

6. Process for producing a product for feeding animals according to claim 3, wherein said maturation step does not start before 8 hours after the step of coating the surface of said kibbles for nutritional purpose with fat.

7. Process for producing a product for feeding animals according to claim 1, wherein said mixing step is executed by means of a screw fed with measured doses of said kibbles for therapeutic purpose and said kibbles for nutritional purpose, the screw rotating and moving the abovementioned kibbles forward, determines a homogeneous distribution of said kibbles for therapeutic purpose among said kibbles for nutritional purpose.

8. Process for producing a product for feeding animals according to claim 3, wherein said screw remixes said kibbles for therapeutic purpose with said kibbles for nutritional purpose during transport in an open container, inside which said maturation step is subsequently performed.

9. Process for producing a product for feeding animals according to claim 1, wherein during said step of absorbing said kibbles for therapeutic purpose increase weight thereof by 5-15% acquiring a density similar to that of said kibbles for nutritional purpose to guarantee distribution uniformity of the kibbles thereof within said food product.

10. Process for producing a product for feeding animals according to claim 1, wherein the therapeutic substance introduced among the ingredients of said kibbles for therapeutic purpose is selected separately or combined in the family of products comprising: vitamine C, lysozyme, bioflavonoids, shark cartilage, contoutine, glucosamine, propolis, Echinacea, Astaxanthin, Papaya, Aloe, Ginseng, Pineapple, Rose hip, Papaya, Resveratrol, Carnitine, Resveratrol, and other mineral, vegetable, animal substances with medicinal effect sensitive to heat and/or oxidant agents.

11. Process for producing a product for feeding animals according to claim 1, wherein the thickeners of said kibbles for therapeutic purpose comprise animal or vegetable protein hydrolysates.

12. Process for producing a product for feeding animals according to claim 1, wherein the thickeners of said kibbles for therapeutic purpose comprise one or more of the following components: dibasic calcium phosphate, maize starch, maltodextrin, animal and vegetable protein hydrolysates.

13. Process for producing a product for feeding animals according to claim 1, wherein the hydrophilic mineral of said kibbles for therapeutic purpose comprises one or more of the following components: calcium carbonate, dicalcium phosphate, magnesium stearate or silica.

14. Process for producing a product for feeding animals according to claim 1, wherein the thickener components of said kibbles for therapeutic purpose acquiring—during said absorption step—said appetizing substances by capillarity upon contact with said kibbles for nutritional purpose, acquire a particularly dark colour which distinguishes them from said kibbles for nutritional purpose.

15. Process for producing a product for feeding animals according to claim 1, wherein said kibbles for therapeutic purpose are subjected—during the step of absorbing fats—to a consolidation step, wherein the fat substances withhold the ingredients of the same kibble for therapeutic purpose compact.

16. Process for producing a product for feeding animals according to claim 3, wherein provided for is a step for screening kibbles after said maturation step and before a packaging step.
